(19) United States
(12) Patent Application Publication
(10) Pub. No.: US 2012/0116840 A1
(43) Pub. Date: May 10, 2012

(54) METHOD AND APPARATUS FOR MARKETING MANAGEMENT

(76) Inventor: Alon OMER, Tel Aviv (IL)

(21) Appl. No.: 13/290,796

(22) Filed: Nov. 7, 2011

Related U.S. Application Data
(60) Provisional application No. 61/412,268, filed on Nov. 10, 2010.

(51) Int. Cl. G06Q 30/02

(52) U.S. Cl. 705/7.29; 705/14.1; 705/14.4

(57) ABSTRACT

A method and apparatus are disclosed for initiating and managing a mobile-based dialog by receiving a response to a request for a dialog, recording information about a respondent correlated with their response, analyzing the response, and sending a return response with a request to continue the dialog. Responses are individualized to particular consumers and may establish a market of one. Personal and/or relevant information may be sent between a consumer and a brand based on previous patterns unique to an individual consumer, and unique to individual preferences. Privacy of a consumer is maintained. The method may be applied to clinical trials and surveys.

### BACKGROUND

Mobile marketing may face challenges and concerns such as privacy issues, spam and questionable relevance to a target audience. Traditional mobile marketing methods may target consumers and may be based on demographically based data. Demographic segmentations may be of limited resolution and may be by a zip code or by a household. Analysis of marketing data may be limited by such resolution limitations, and may be limited to statistically based analyses.

Location based mobile services may raise concern of consumers over potential privacy violations, and may be related to location disclosures. Other services may be based on consumers following a brand using networks, such as social networks, that may be web based, e.g., Facebook, Twitter, and may allow consumers to follow promotions, sales events, and the like, of a brand only by subscribing to receive such promotions from a brand. Such services, and other similar promotional services may provide to subscribers, or followers, marketing information via mass distribution, e.g., “spray and pray”, which may not contain significant market targeting, and/or may contain a low relevancy to any one recipient.

### BRIEF DESCRIPTION OF THE DRAWINGS

FIG. 1 is a conceptual block diagram in accordance with an embodiment of the invention;

FIG. 2 is a conceptual block diagram in accordance with an embodiment of the invention;

FIG. 3 is a flowchart illustrating operation of a method in accordance with an embodiment of the invention;

FIG. 4 is a flowchart illustrating operation of another method in accordance with an embodiment of the invention;

FIG. 5a is a conceptual block diagram of a user interface in accordance with an embodiment of the invention;

FIG. 5b is a conceptual system diagram in accordance with an embodiment of the invention;

FIG. 6 is a flowchart illustrating operation of another method in accordance with an embodiment of the invention;

FIG. 7 is a conceptual block diagram of a dialog engagement in accordance with an embodiment of the invention; and

FIG. 8 is a flowchart illustrating operation of another method in accordance with an embodiment of the invention.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of an embodiment of the invention. However, it will be understood by those of ordinary skill in the art that an embodiment of the present invention may be practiced without these specific details. In other instances, well-known methods, procedures, components, and circuits have not been described in detail so as not to obscure the present invention.

Mobile marketing and advertising may be related to online or Internet advertising, and may have a greater reach, or penetration ability. Mobile advertising may be targeted toward mobile phones, and may also be targeted toward any mobile device, e.g., mobile computing platforms, mobile communication devices, and combinations of such devices and platforms and others. Advertising and other media industries may recognize a large and evolving mobile market and may choose to focus expenditures, e.g., advertising expenditures, on such a market and/or elements of such a market. Mobile devices may be Internet-connected devices. Advertising may be distributed to such mobile devices, and may be passive advertising or may be interactive advertising in which user involvement may be part of the ultimate distribution.

Mobile devices, e.g., mobile phones or telecommunication devices, may be used during activities, e.g., shopping, in which advertising may be targeted. For example, a consumer may use an Internet-connected mobile phone to research product information while inside a store selling such a product. Mobile marketing may provide a service that may be push-based, in which advertisements may be sent to mobile devices or Internet-connected mobile devices. Mobile Marketing may also be pull-based. Pull based services may be based on requests sent from mobile devices. A consumer may request information, and may pull such information through a delivery system, e.g., an MMP.

Concerns of privacy and spam from a consumer's perspective and/or concerns of relevance from an advertiser's and/or a consumer's perspective may exist. An advanced mobile marketing solution may create a personal and relevant consumer message. A database (DB) may be formed, may be individualized, and may be based on an attribute, e.g., behaviorally based, and may be associated with features, for example non-intrusive, voluntary participation or a two-way brand-consumer dialog.

A dialog may be any exchange of information between a consumer and a brand. A dialog may be conducted in accordance with an order that may be designed by a brand. A consumer may be able to choose to terminate or continue with a dialog at any time, by exercising opt in or opt out privileges. A dialog may be a series of questions and responses, and may be conducted via a consumer's mobile device. A consumer that may choose to postpone a response may be considered non-responsive. A non-responsive consumer may be considered to be electing to terminate and/or postpone engagement in a dialog. A non-responsive consumer may not receive further promotions, information, messages, etc. A response and/or active engagement originating from a consumer may indicate continuity and/or a renewal of a dialog.

Mobile marketing may be associated with a management methodology and/or a system, may include a number of marketing tools and may be connected to a DB. Such a DB may be a static database or a real-time analytical behavioral DB. Individualized consumer behavioral patterns may be stored by such a DB, and information may be gathered through a variety of means. Information and entries of such a DB may be obtained from engagements between consumers and an advertiser, consumers and a brand or consumers and another retail or service entity, and such engagements may be of a voluntary nature. Engagements may enable brands to establish dialogs with consumers that may be close and personal, and may be part of a bi-directional process in which behaviors and/or patterns of each may be learned by the other.

A store, company, or brand may desire to increase sales by establishing an incentive or loyalty program. A brand may be a store, a company, a point of sale (POS), point of service, and/or any entity (store, manufacturer, service provider, etc.). Such a program may be designed to operate between a brand and a consumer via a consumer's mobile device. A brand may make, by display or other means, an initial offering, such as an incentive or discount, to a consumer. To prevent a brand from disturbing a consumer or interrupting a consumer's privacy, a consumer may opt-in to an incentive being offered. A consumer that chooses to opt-in may offer a brand to store one or more identifying information elements, e.g., a mobile phone number and/or a MSISDN, in return for an incentive or a discount on products or services offered for sale by a brand. Such an exchange may initiate a dialog between a brand and a consumer, and a consumer may at any time opt out of a dialog and thereby terminate consent to further analyze information that may have been associated with a consumer's mobile number.

Some dialogs may purge information associated with a consumer that has selected to opt out of a dialog. Redemption and/or receiving of incentives by a consumer by using messages and/or graphics sent to a consumer's mobile device may be followed by additional incentives, or coupons, or any other of a consumer's valuable information or needed service alike, that may be sent to a consumer's mobile device. Redemption and/or receiving of incentives may also result in a consumer being elevated in a loyalty program, where such program may be specific to a brand. A consumer's mobile device and/or a consumer's personal email address may be used to communicate with a brand, and for receiving and displaying coupons for redemption. Redemption may also be considered as receiving, receiving and/or transmitting, redeeming or otherwise completing an information transaction.

Also, loyalty levels may be displayed visually on a mobile device along with coupons, in conjunction with an incentive program created and/or managed by a brand. Consumer information, including purchasing and/or behavioral patterns may be stored and analyzed by a brand, and may be used to modify incentives, loyalty programs, marketing programs and/or sales strategies. Modification may be made in near real-time, e.g., on the fly.

A brand may also decide to allow a third party, a mobile marketing platform (MMP) and/or management entity to manage an incentive program. The incentive program may, for example, allow a brand to focus more on its products and/or services. A brand may use a user interface, or a composer, to make incentive program choices, for example regarding consumer responses that may result in additional rewards. An MMP may use a database to store, track and/or analyze individual behavioral and/or pattern information of individual consumers. Such information may be collected and/or stored together with an individual consumer identifier, e.g., a mobile phone number of a consumer that a consumer uses to respond to incentives and collect rewards. Information stored and/or analyzed coincident with a consumer identifier may be used to individualize marketing program aspects and/or incentives, and may also be used to track and/or respond to an individual consumer's progress in an incentive or loyalty program. A mobile phone number may refer to an actual dialed number, a Mobile Station International Subscriber Directory Number (MSISDN), a Mobile Subscriber International Subscriber Directory Number, an International Mobile Subscriber Identity (IMSI), combinations of such numbers, and the like.

A mobile marketing platform (MMP) may offer service to one or more brands, and in an embodiment may utilize a same database for storing consumer information. An MMP may implement precautions, rules, and/or safeguards, e.g., firewalls, to prevent one brand from accessing information collected in accordance with a program of another brand, e.g., a multi-tenant architecture. A consumer may appreciate such safeguards with regard to privacy or other concerns, and a consumer may be requested to opt in to any allowance of one brand having access to any data collected by a program of another brand. An MMP may manage such interactions. In an embodiment, a brand may offer a consumer an incentive to choose to opt in to a data sharing among two or more brands. An MMP may manage an interface utility, or composer, that may allow a brand to determine program rules, including messages sent, e.g., multimedia service messages, responses that may be received from consumers and/or loyalty levels. A composer may include sufficient complexity to allow a brand to design and/or manage a loyalty program comprehensively. Such design and/or management may be performed locally or remotely. An MMP may also manage communications between brands and consumer's mobile devices, and a brand may be free from interfacing with networks, e.g., mobile phone networks, computer based networks or cloud networks, other than an MMP processor based device or network.

Methods and apparatuses may relate to mobile marketing and advertisement solutions, services and/or systems. Engagement and/or management methodologies, systems, software and a database may enable construction and operation of a dialog between a consumer and a service or goods provider, e.g., a brand, in which such dialog may be longstanding over time, may be individually relevant, may allow voluntary participation and may be conducted using mobile devices, e.g., a consumer's mobile phone. Voluntary participation may be by a variety of methods, for example a full opt-in/opt-out mechanism for communications. Construction and operation of such a dialog may be by a personally designed method, on a consumer-by-consumer basis, and may be non-intrusive.

Mobile marketing campaign methodologies may be push based, ad-hoc, or based on demographically related data, or they may be based on a methodology of building a voluntary, mutual, long-term dialog. An individual consumer's behavior patterns as reflected from, or presented through, a dialog process, may be recorded in a database (DB), e.g., an analytical DB, and may be utilized at a later time to improve, or perfect, future engagements, dialogs or campaigns, and may be for a benefit of participating parties. Such an approach may bring value to both a consumer, or mobile device based consumer and a brand.

An embodiment of the invention may enable brands and/or firms to establish a long standing, close, personal and relevant dialog with their consumers, in a continuous learning process, and using full opt-in/opt-out safeguards and mechanisms. Reaction by an MMP may be only by request of a consumer. An embodiment of the invention may be enabling, providing and/or facilitating a long standing mobile-based dialog, that may be powered by a behavioral database.

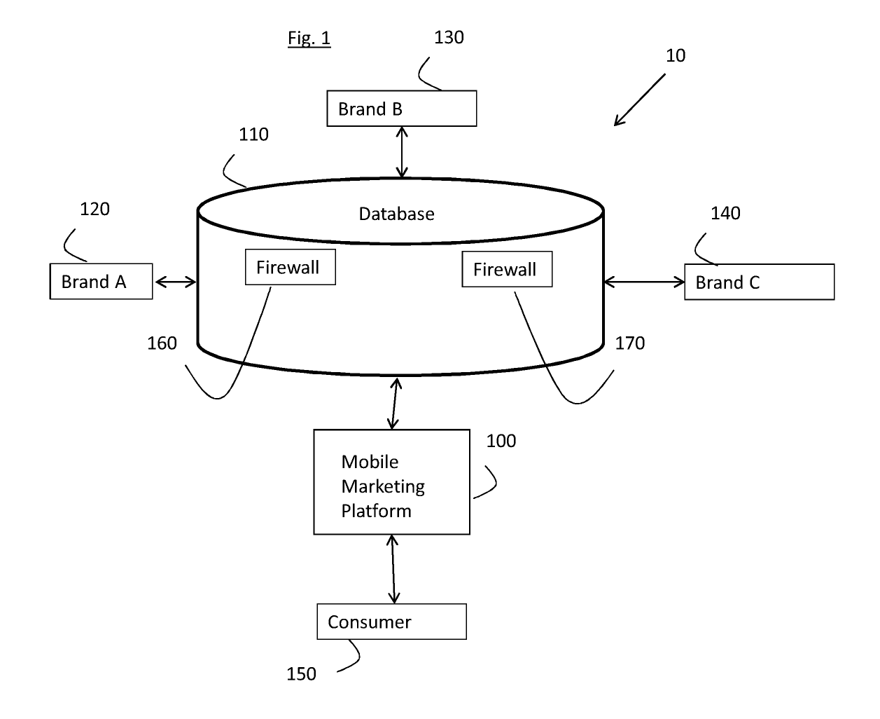

Reference is now made to FIG. 1, which is a conceptual block diagram of apparatus/system 10, in accordance with an embodiment of the invention. Mobile marketing platform (MMP) 100 may be used to manage a marketing campaign that may be based on consumer responses to surveys and/or incentives and/or other valuable or desired information or services to a consumer, and may be personalized to behaviors of respondents. Information may be stored by database 110 and managed by MMP 100. MMP 100 may process information, including analyzing behavioral patterns, preferences, etc., of one or more consumers 150.

MMP 100 may also manage incentive programs geared toward consumers 150, that may be based on such analyses. MMP 100 may control or limit a brand's access to consumer 150 information that may be collected by activities originating from another brand. MMP 100 may establish and maintain a security protocol that may permit cross access, if certain criteria, e.g., prior permission from a consumer 150 to share access, may be met.

MMP 100 may determine management protocol for such cross access, for example a permitted length of time or until a new parameter, e.g., an opt-out signal, may be received. MMP 100 may manage connections to one or more consumers 150 via various network connections, e.g., the Internet, a cellular telephone network, a wireless network, or the like. Mobile marketing platform (MMP) 100 may use Short Messaging Service (SMS), multimedia messaging service (MMS), electronic mail (email), Wireless Application Protocol (WAP), Location Based Service (LBS) or other methods of communication between and among consumers 150. MMP 100 may manage protocols for access to and from such carriers and/or aggregators.

Database 110 may be used to store information about consumer 150, and/or other information mobile marketing platform (MMP) 100 may use during analysis or management functions. Database 110 may store information from brands, for example Brand 120, Brand 130 and/or Brand 140, that may be used for marketing or incentive purposes, as may be managed by MMP 100. Any number of brands may be connected, physically or operatively to database 110. One or more firewalls 160 and 170 may be used by database 110 to segregate access to information by brand 120, 130 or 140. Firewalls 160, 170 may be physically implemented, implemented in software and/or implemented in a multi-tenancy architecture. In an embodiment firewalls 160, 170 may be features.

Information that may be collected from consumers 150 may be collected from a management function of MMP 100 and may be related to a single brand, e.g., Brand 120. Access to the collected information may be provided to a brand related to collection of such data. Access may be blocked by firewalls 160 and 170 to prevent other brands, e.g., Brand 130 or Brand 140, from accessing such information. A database 110 may be a standalone database, or it may be part of or within MMP 100. A database 110 may be co-located to MMP 100, or it may be remotely located and operatively connected to MMP 100. A database 110 may be any type of database, such as including a memory or a virtual memory or a cloud-based database, and may include a processor for processing database functions. Database 110 may be a new database, an existing database, a behavioral database, or a combination of databases. An embodiment may be a combination of a behavioral database and an existing database.

A consumer may have an option to provide consent to an MMP to allow “cross shopping” and/or collaborative filtering. A consumer may be a gatekeeper for such cross information access. A one-time key may be used, and may be required for “cross shopping” and/or collaborative filtering to occur. Cross access, cross shopping and/or collaborative filtering may be statistically based. Cross access, cross shopping, collaborative filtering and/or a key may be generated via a dialog. Cross shopping may be a consumer driven consent-based activity.

Brand 120, Brand 130 and Brand 140 may each be a retailer, a store, a point of service, a point of sale, a company and/or any corporate entity that may engage in marketing, data collection, and/or analysis activities. Each of these entities may be of a same type or of different types or classifications. A Brand 120, 130 or 140 may create and/or maintain incentive programs, loyalty programs, marketing campaigns, new drug clinical trial data campaigns, etc. Each brand may create and/or maintain unique programs or campaigns. Each brand may be independent, and unrelated to each other. Each brand may have a unique customer pool, which may or may not be common to other brands, but may not have access to customer information from other brands, unless MMP 100 may allow cross access. A Brand 120, 130 or 140 may manage a program or campaign by using an interface, user interface (UI) or other like mediums that may be designed to work with MMP 100.

Consumer 150 may be a customer, potential customer, of a product and/or service offered by a brand 120, 130 or 140. A consumer may be operatively connected to mobile marketing platform (MMP) 100 by a mobile device, a network connected device or like communication medium, and may connect via a network, e.g., the Internet, a cellular telephone network, a wireless network, or the like. Consumer 150 may respond to requests, surveys and/or incentives that may be offered or presented and may originate from a brand 120, 130 or 140, and may establish communication or a dialog with such brand. Consumer 150 may be establish communication or a dialog with one or more brands by a variety of means, for example by opting in to an offer to communicate, responding to an inquiry or redeeming a coupon or incentive offer. Permission to share identifying information of consumer 150 may be controlled by consumer 150 and communicated to MMP 100. Identifying information may be disclosed in an anonymous fashion among brands, and may be allowed by an opt-in selection of a consumer. Consumer 150 may be rewarded by responding to incentives and/or offers and/or any relevant needed information by obtaining membership to program levels, e.g., loyalty program levels, and may be presented with altered sets of surveys and/or incentives based on such levels. Consumer 150 may manage personal preferences and dialogs from a mobile device, e.g., a cellular telephone or an Internet telephone, and/or an Internet web site.

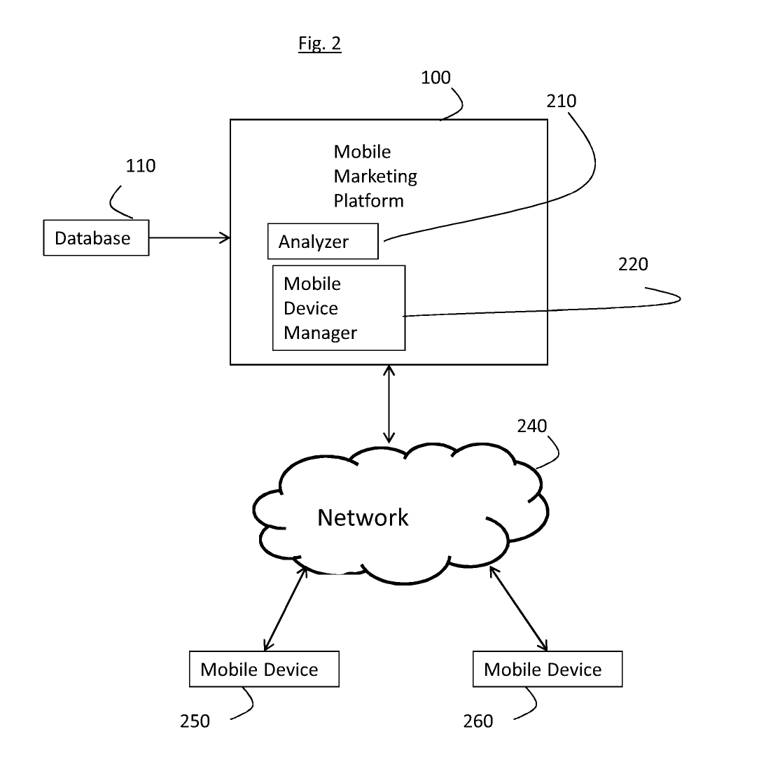

Reference is now made to FIG. 2, which is a block diagram of an embodiment in accordance with the invention. Mobile marketing platform (MMP) 100 shown may be an exemplary implementation of MMP 100 and may contain an analyzer 210 and/or a mobile device manager (MDM) 220. MMP 100 may be physically or operatively connected to a database 110, or database 110 may be contained within MMP 100. MMP 100 may be physically or operatively connected to a network 240, e.g., an electronic communication network, such as the Internet, a cellular telephone network, other cloud-based networks, etc. MMP 100 may be operatively connected to one or more mobile devices 250 and 260 via network 240. MMP 100 may collect consumer data and/or store and access such data to and from database 110.

Analyzer 210 may perform analysis, sorting and/or processing functions using data that may be collected and/or managed by MMP 100. Analyses performed by analyzer 210 may be used by brands for designing and/or managing promotional or marketing campaigns.

Mobile device manager (MDM) 220 may manage connections between MMP 100 and a plurality of mobile devices 250 and 260, that may operate on a same or on a plurality of networks 240. Mobile device manage (MDM) 220 may use SMS, multimedia messaging service (MMS), email, WAP, LBS or other communication protocols, as appropriate for a network 240 to which a mobile device 250 or 260 may be connected.

Mobile devices 250 and 260 may be operatively connected to mobile marketing platform (MMP) 100 by network 240. Any number of mobile devices may also be operatively connected to MMP 100 by network 240. Mobile device 250 or 260 may be a cellular telephone, smartphone, Internet phone, personal digital assistant (PDA), iPhone, Android, mobile computing platform or other personally identifiable device. A mobile device 250 or 260 may have a unique identification, e.g., a mobile phone number. The unique identification may be used to track related information that may be managed by MMP 100, stored by database 110 and/or reviewed by one or more brands.

Consumers may be attracted to engage in a dialog that may be compatible with specific personal preferences. A consumer may be provided with a unique item, or benefit, and may be in accordance with one or more elements of a dialog, e.g., information or a coupon. A benefit may be an incentive, for example having a promotional and/or an informative significance, to continue with a dialog. A subsequent informational element or request may be provided and may be an incentive to participate in a future engagement, or personal engagement. Such a pattern may be repeated. Each repetition may provide additional personalized information, where such personalization may be used to focus or target future engagements. Engagements or dialogs may be continuous or may be conducted over a period of time.

Personal choices made by an individual consumer may be recorded in an analytical DB through an engagement process, e.g., a continual engagement process, with an individual firm, or brand point of service and/or point of sale. Various identifiers may be used to identify an individual consumer, and a unique identifier (ID) may be associated with and individual consumer. A unique ID may be associated with a number, e.g., a mobile phone number, and may be disjointedly stored in a DB, where disjoint segregations may be by brands. Storage may be for a variety of purposes, particularly for future promotions and/or campaigns. Such personal preferences records may be accessed on a per brand basis, a per consumer basis, or a per specific campaign reference, or a combination, and may be leveraged and/or exercised for tailoring of personal and/or relevant messages, promotions, products, advertisements or the like, to an individual consumer, and may be in accordance with a consumer's personal preferences and/or choices. A consumer experience may be constantly improved by providing data that may be relevant and/or personal, and may be subject to a consumer's previous choices. Data provided may be based on relevant and/or personal data, and may not rely solely on other methodologies, such as statistically based traditional mass advertisement or other methodologies, e.g., “spray and pray” methodologies.

A consumer's behavior may be linked to an ID, e.g., a personal mobile phone number, and may not rely on containing additional personal data, and such additional personal data or details may not be gathered or disclosed. Personal data collected and referenced accordingly may maximize privacy of a consumer. Each brand may build individual relevant consumer's behavior data profiles, and may be used to leverage future campaigns. A provision, e.g., a privacy provision, may be that unless previously agreed between all participating parties, including all participating brands and consumers pairs per each marketing effort, a consumer's mobile phone number, or ID, may not be shared between brands. Such a provision may facilitate use of a common DB that may service a plurality of brands.

A DB may be a traditional DB or it may be cloud based or have a data-less architecture. Data may build up, separately, per each client-customer, or brand-consumer, pair, in an analytical behavioral DB, and may be from non-intrusive, voluntary and dialog interactions. Such interactions may be designed to personalize messages, and may bring unique and/or individualized and valuable information and/or services to each consumer. Data may be gathered through multiple voluntary engagements and may build up, or accumulate, within, and segregated by, each brand-specific DB, and may be in a continuous evolutionary process, e.g., a spiral, where data quality may be perfected through multiple engagements with each consumer, and such a process may be analogous to a linear regression-like model. Such data may be analyzed, learned and/or leveraged by a brand, and may be used to perfect a future marketing campaigns, e.g., mobile marketing campaigns, by delivering better, more precise and/or relevant messages. Such a methodology may allow for brands, e.g., stores, credit cards, supermarkets, to gather information not only with a resolution that may be per unit, e.g., per family, where a limited set of conclusions may be drawn due to multiple users among a set, but where a message may be tailored, or perfected, with a precision to an individual, e.g., consumer resolution, level.

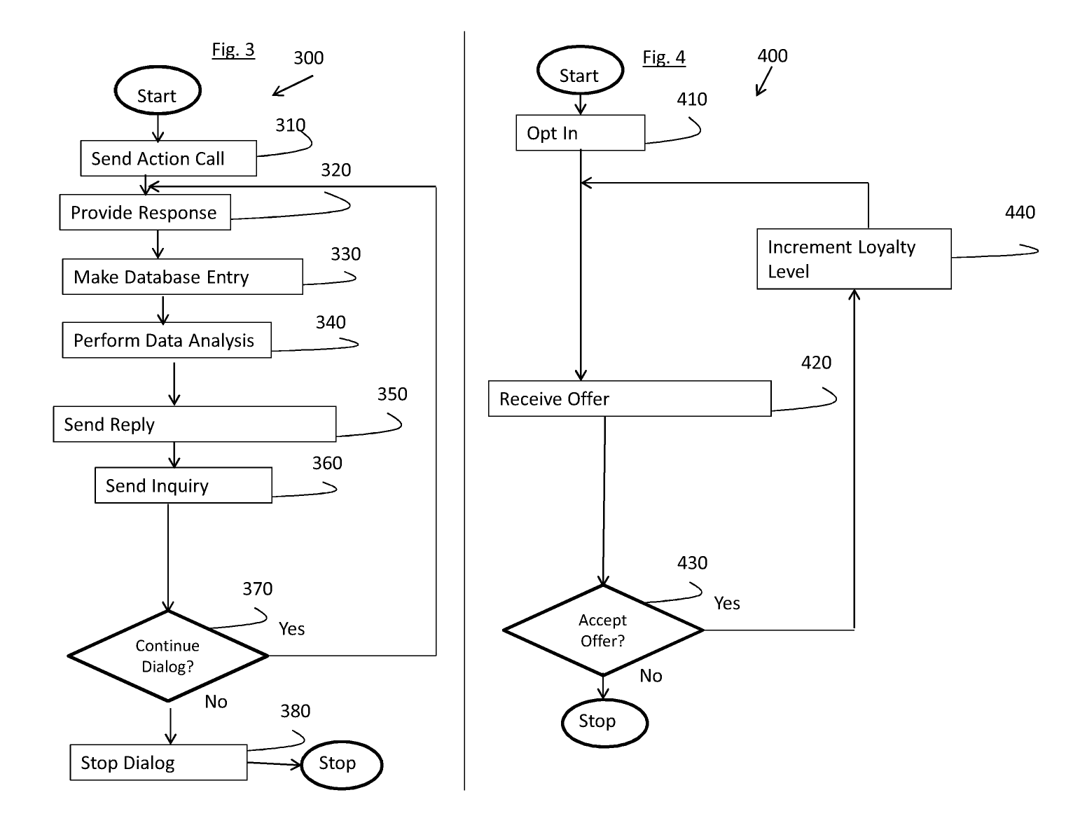

Reference is now made to FIG. 3, which is a flowchart illustrating operation of an exemplary method 300 for managing a dialog among consumers and brands. An action call (operation 310) may be sent or broadcast by a brand, and may be delivered by a variety of media, e.g., radio or television advertisements, billboards, on a product package or on a receipt, signage or in-store displays and/or a web page, or the like. Included in the action call (operation 310) may be instructions for responding to such a request for initial contact, or dialog initiation, e.g., a message to send via SMS to a particularly identified receiving number. A consumer may provide a response (operation 320) using a device, e.g., a mobile device, and a response may be according to instructions provided by the action call (operation 310). A response (operation 320) may include permission to store personally identifiable data, e.g., a mobile phone number, and communication of a desire to initiate a dialog with a brand that may have sent action call (operation 310). A database entry (operation 330) may be made and may include such personally identifiable information as described herein which may be correlated to a response (operation 320) received. A database entry (operation 330) may be managed by a mobile marketing platform (MMP). Data analysis (operation 340) may be performed by an MMP and used by a brand. A reply (operation 350) may be sent to a consumer via a mobile device, and such a reply may confirm a dialog between a brand and a consumer. An inquiry may be sent (operation 360) by a brand to a consumer, using an MMP, with a request to continue a dialog (operation 370). A request for continuation of a dialog may include an offer, an incentive or a coupon by brand to a consumer. A request may occur promptly, or it may occur at a future time. A positive response from a consumer will continue a dialog. A dialog may stop (operation 380) upon a negative response.

Standard printed or digital couponing methodologies that may exercise mass marketing push oriented methods may be used. Other methods, e.g., Mobile Viral Computing or Mobile Social Couponing, may be used. A method may initially send a relevant and personalized coupon and/or benefit according to preferences of each consumer, and may be either derived from previous engagements, per a consumer ad-hoc request, or other similar methods. A consumer may receive a relevant coupon and/or benefit and an opportunity to share it with peers and/or friends and/or family may be provided. A pool of relevant audience members for each coupon and/or benefit may be sorted by a consumer. A consumer may spontaneously sift out those elements that may not be of interest, and simultaneously may forward to whom a benefit may be expected to be appealing. A marketing effect, e.g., a relevant viral/pyramid marketing effect, may be implemented, and a consumer may effectively function as a sort of agent, e.g., a sales agent, of a brand, and may be at minimal cost. An effective triple-win action may be realized among consumer, brand and peers, by furnishing peers with a personal recommendation.

A coupon may include an embedded barcode (e.g. QR code) that may facilitate keeping full record of every engagement between the consumer and the shop, for example, using a management DB.

The barcode or QR code may include, for example, shop ID, campaign ID, coupon serial number, engaged customer ID (e.g. the customer's mobile phone number), or other information.

According to an example, the barcode or QR code may be scanned in the store, utilizing QR mobile application software, such as, for example, free downloadable software. The scanned barcode or QR code may then be send to the management DB.

A unique barcode or QR code facilitates knowing not only how many coupons were redeemed (like in the printed one) but also who redeem them. This may also allow retrieving unique consumption patterns for each individual user and utilizing it to build and digitally manage a loyalty club program per each shop.

A mobile based SMS/MMS and/or mobile Internet-based individualized satisfaction survey may be used. Various survey methods, and customer satisfaction survey methods, may be web based, paper based, interactive voice response (IVR) based, or the like, may be presented to consumers at a distance, both in time and/or space, from a purchasing occurrence, and may be in a common fashion, and may be strenuous to perform. Another approach may be utilization of a mobile device to attract customers to participate in a customer survey that may be close, in time and/or space, to a purchasing event, and may be as part of a fuller dialog. A plurality of purposes may be served. An immediate feedback may enrich a dialog, and may make it into a two-way communication. It may become a more natural part of an engagement and may reduce suspiciousness, and may increase a participation rate.

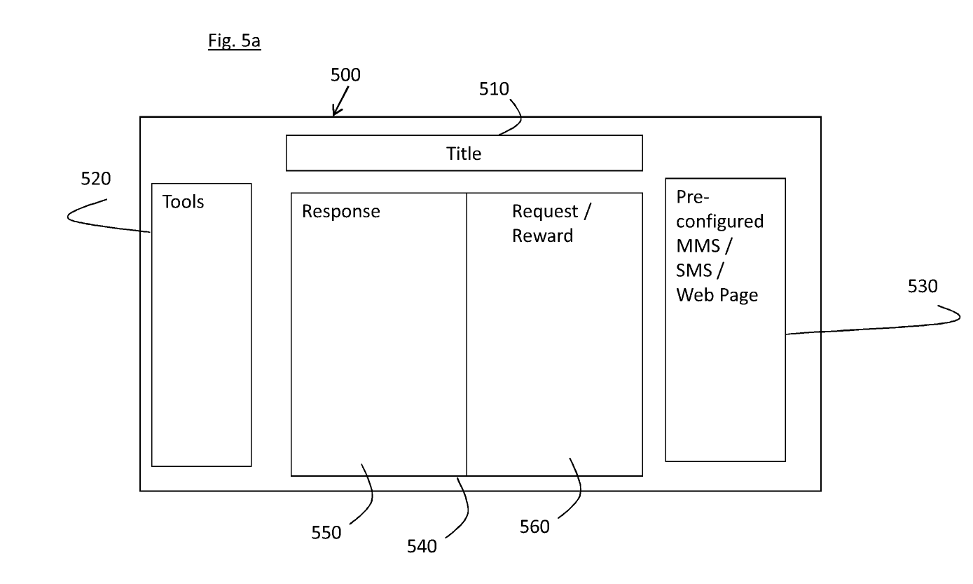

Reference is now made to FIG. 4, which is a flowchart illustrating operation of an exemplary method 400 for consumer communications with a brand. A consumer selects to opt in (operation 410) to a dialog that may be offered by a brand, POS, restaurant, or the like, and may include an incentive, and may use a mobile device to communicate preferences to opt in, begin and/or continue a dialog and/or receive confirmations or other messages in accordance with a dialog. An offering may be made by a static display, and may be made at or near a point of sale, or potential point of sale and/or on a product package. A consumer receives an offer (operation 420) from a brand, and may include, for example, an incentive in return for participation in survey or marketing activities. A consumer may accept an offer (operation 430) by redeeming a coupon or providing a response to a survey, or other acceptance communications, and such acceptance may be by using a mobile device. A brand may increment a loyalty level (operation 440) of a consumer, and may alter offers sent to a consumer based on a loyalty level. Loyalty level information may be communicated to a consumer on a consumer's mobile device. Loyalty levels may be incremented in an increasing or decreasing direction, or may not be incremented if, for example, multiple activities may be required to achieve a next level. Loyalty levels may be designated by visual identifiers and/or names. A loyalty level increment may be based either on a quantitative algorithm, a qualitative algorithm, or both, and may correspond to a consumer, for example, climbing in a loyalty value chain.

A consumer, rather than being presented with endless, multiple dozens of questions that may tire a consumer of surveys, e.g., customer satisfaction surveys, another method may be exercised. Survey questions may be prepared, and they may be split into separate categories, e.g., polls, and each may contain a relatively small number of questions, e.g., 3 to 5 questions in each. A consumer may be presented an opportunity to participate in a survey, and such survey may be close, in time and/or distance, to a point of a shopping experience. An opportunity to participate in a survey may be presented in a variety of ways, for example by presenting a poster at a point of sale, on a receipt, or as part of a dialog process that a consumer may already be participating in. A relatively small number of survey questions, e.g., 3 to 5 questions, may be sent to a consumer in a standard format, e.g., a multimedia messaging service (MMS) format, or by Wireless Application Protocol (WAP) via utilizing mobile Internet services. A consumer may provide answers to a survey, and such answers may be returned promptly by a variety of methods, for example an SMS that may contain such answers. A format may be of a 3 to 5 digit number as a response. For example, questions may be in a multiple choice format where a number of an answer may correspond to each question, and a sequence of answers may be sent in numerical question order as a single, multi-digit response, e.g., Q1-3, Q2-5, Q3-1 may be sent as a text message of 351. A consumer may be provided with immediate gratification in return for effort and time in responding, and such gratification may be a discount, e.g., a discount coupon. A survey's question's may be cycled into other polls, each time a survey's participation request may be received in a system, and may be done in order to exercise a full survey questioner.

A consumer may have other opportunities to engage with a brand, and provide inputs dynamically, e.g., on the fly. Such opportunities may be during a shopping experience or promptly thereafter, and such timing may increase survey response validity and/or participation rate. An interaction may further build a relation and a loyalty between a brand and a consumer, and a consumer may be instantly rewarded for time spent, and be without regard to a sweepstakes and/or lottery prospect.

A methodology may be described as follows. Utilizing a multimedia messaging service (MMS) format, or similar visually enabled formats, survey questions may be presented in a common and/or friendly manner. A consumer may be enabled to reply with one or more answers in a simplified format of a number consisting of a small number of digits, e.g., 3-5 digits, where a flexible syntax may be enabled in a system to detect inaccuracies, such as typographical errors. A full survey's questionnaire may be reduced into a subset having a few short and clear questions that may contain, for example 3 to 5 questions each, and may cycle those in a system to exercise a complete survey questionnaire. Answers to this subset questionnaire from multiple individuals may be combined to form a single sample representing a complete response to the full survey.

A survey may be ad-hoc or it may be an individualized mobile-based survey. A survey may be a part of a continuous dialog process, and may improve an ability of a surveyor to attain more valid and/or comprehensive data, and such data may be based on a long-standing engagement, as an alternative to one-time encounters. A system may also mix and match a survey's questioner, and may do so by personalizing specific questions, per consumer, and may be according to each consumer's previous behaviors, as may be recorded in a DB during previous consumer-brand engagements.

A method may be one where a consumer may request a brand to stop sending paper based coupons, e.g., by mail, and instead send electronic coupons, e.g., mobile coupons, directly to a mobile device. Such a method may be an Ecologic or green coupon method, or an E-coupon or paperless coupon method. Paper based coupon catalogs may be sent to residential homes, and may be based on characteristics, such as zip codes, and may not be personalized to specific preferences of recipients. A method may be designed to enable brands to propose to their consumers and/or loyalty club members a greener, more personalized, relevant and/or cost effective way to attain their unique chosen coupons, and be in a digital format, that may be sent directly to a personal mobile device. A method, e.g., an Ecologic coupon method, may be exercised by a consumer or a loyalty club member being invited to decline paper coupon catalogs that may be currently received from a brand. In their stead, personal chosen coupons may be received directly to a mobile device. Such a transaction may be initiated either while a consumer may be already browsing a brand, e.g., a brand web site, logging into a member database, or member club account, or may be through an ongoing dialog process. A consumer may make a selection, e.g., choose to go greener, and may be directed into an interface, e.g., a web interface, that may allow a consumer a choice of either relevant product categories or specific coupons that may be desired to be received. Such coupons may be received immediately or at a future time. For example, a consumer may choose to promptly receive specific current coupons A, B and D, and may also select, or check a box, for other items, e.g., pet food or household detergent, for participation in future promotions and/or sales.

Both a consumer and a brand may exercise a more environmentally and eco-friendly greener shopping behavior. Brands may reduce production, printing, shipping and logistics costs and hassles, and consumers may enjoy a better and more efficient way to obtain only relevant and personalized marketing information, promotions and benefits.

In an embodiment, other applications of the invention may be found. An application for tracking individualized behavioral or other patterns, or survey results, may be performed by the invention. For example, Federal Drug Administration (FDA) clinical regulations may require a new pharmaceutical company to perform clinical tests and/or trials with humans, and present, for new medicines, their performance, efficiency, efficacy, and possible side effects. Methods may be mostly based on post-trial period questioning, and there may be potentially severe inaccuracy in reporting, which may be due to a lack of memory of any adverse occurrence, e.g., a specific stomach ache or diarrhea occurring on a certain night during a trial period. Such a method may be based on a statistical poll survey, may not include all patients and may provide a pharmaceutical company an outcome of a trial performance following a period, e.g., months, after a trial may have ended. A method, e.g., a Clinical trial mobile facilitator or a Pharmaceutical new medicine clinical test facilitator, may provide a pharmaceutical company monitoring capabilities of clinical trials performance and side effects for an entire participating patient poll in near real-time.

A real-time over-all view, or picture, of a trial progress may be enabled to be obtained, and may help to better control performance, detect potential problems promptly, if such problems may develop, and may eventually shorten a new medication approval cycle by attaining clinical trial data in real-time, rather than by a post-mortem mode. Additionally, a two-way, always on, mobile communication with each patient may increase both patient trust and loyalty, and cooperation, and may improve monitoring of a trial performance.

A method, e.g., a Clinical Trial Mobile Facilitator, may be exercised by each patient, or a group of patients, may receive a daily communication on a mobile device. Such a communication may be in a form of a reminder in a multimedia messaging service (MMS) format, or SMS or automated voice message or Interactive Voice Response (IVR), e.g., to take medication. Communications may be made multiple times each day, or on other schedules. Each MMS message may contain either a random or a methodical set of questions, e.g., a clinical question or questions, and each may be presented to a patient. A patient may provide answers by replying with an SMS message, that may contain answers to questions in a numerical sequence, e.g., a sequence of 3 to 5 digits. For example, there may be three questions and a patient may answer each, e.g., Q1-3, Q2-5, Q3-1, and a response sequence may be a single 3-digit number numerical text message, e.g., 351. A clinical manager may review results sent by each patient utilizing interfaces, e.g., dashboards, as per a choice of a manager. Analysis and response per a specific need may be performed, and may be according to gathered data, to a resolution precision of an individual patient. Various clinical messages may be exercised per each patent, and may be according to each patient's personal feedback and reaction to new pharmaceutical treatments.

A method of bundling both complimentary and non-complimentary, e.g., alternate coupon, information utilizing a personal mobile device may enable marketers flexibility of mix and match of numerous product combinations in near real-time, and in an easy to use manner. Some significant advantages may be realized. A brand may test, and when desired amend, different promotions in real-time, or on the fly, and may omit costly long-term logistics and production processes that may typically be involved in traditional methods, e.g., printed media promotions, on a shelf coupons, catalogs, and the like. Similarly, testing may be enabled of different bundles of such items, and may be performed in various geographical areas, and may provide a better match of different strokes or needs that may be related to different areas. For example, a large retailer may desire to bundle its sharp cheddar cheese with wine in a New York City area, and may want to bundle cheese with crackers in Wichita, Kans., or bundle related to different climates.

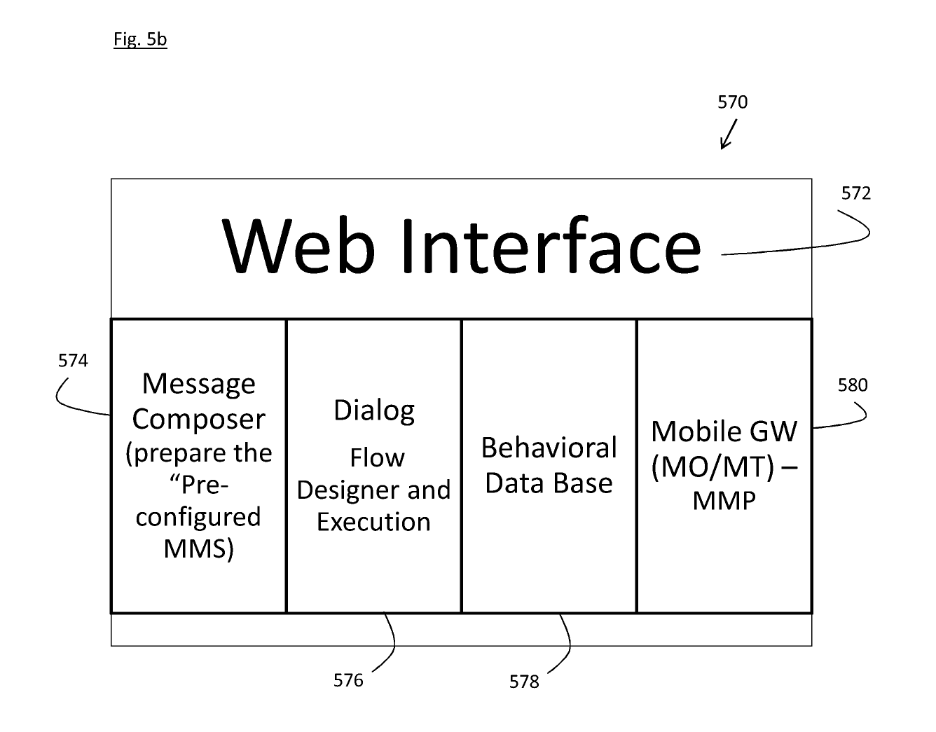

Reference is now made to FIG. 5a, which is a block diagram of an embodiment of the invention. Display 500 may be used by a brand to create and/or manage a marketing campaign. Display 500 may be presented on a computer display, a laptop display, a mobile device display, or other electronic display media. Display 500 may be comprised of tools section 520, pre-configured multimedia messaging service (MMS) section 530, title section 510 and request/reward and response section 540. Display 500 may be used to configure a variety of elements of a marketing campaign, e.g., coupon, incentive and response selections, and may be referred to as a composition utility, e.g., a Composer. Display 500 may facilitate a user interface (UI) between an operator, e.g., a marketer or a brand, and a computing device that may be used to configure electronically controlled and/or stored elements of a campaign, e.g., a marketing campaign. For example, display 500 may be used to adjust a time flow or sequence of events of a campaign, create coupons and/or incentives that may be used during a marketing event and/or create and/or manage reminder notices that may be sent to respondents. Display 500 may be used to create and/or manage surveys that may be sent, and/or create text or text messages and such messages may have limits that may be based on technology of receiving devices or mobile devices, e.g., a 160 character limit for certain devices. Display 500 may be used for multimedia message creation and/or design, and/or for viral composition or other marketing or survey applications. Any combination of applications may also be used, and may be displayed in any order, and such combinations and/or ordering may be in accordance with a design of a marketing and/or survey plan.

Title section 510 may be used to display a title of an activity being performed and displayed on display 500. Title 510 may describe, for example, a Campaign Composer UI, a Time Flow, e.g., top to bottom, a Coupon Composer, a Complementary Composer UI, a Reminder Composer UI, a Survey Composer UI, a Text Composer UI, a Multimedia Composer UI, a Viral Composer UI or other marketing or survey applications.

Tools section 520 may be used to select an activity to be addressed next, and such selection may be by a user interface with an electronic media displaying display 500. Such activity, following selection, may be described in title section 510, and display 500 may change to display elements of a selected activity. An activity list may be predetermined, or may change depending on selections made. Tools section 520 may display any tools that may be related to a marketing and/or survey campaign or event, e.g., coupon, complementary, reminder, survey, text, multimedia, viral or other activities.

Preconfigured multimedia messaging service (MMS) section 530 may be used to select an MMS that may be presented to a consumer, and such selection may be by a user interface with an electronic media displaying display 500. Such an MMS, following selection, may be additionally displayed in other sections of display 500, e.g., response and request/reward section 540. An MMS list may be predetermined, or may change depending on selections made. Preconfigured MMS section 530 may display any MMS that may be related to a marketing and/or survey campaign or event, e.g., a coupon for a free piece of cake that may include a picture of a piece of cake or a message of regards to enjoy some cake. Preconfigured MMS section 530 may also display short messaging service (SMS) messages and/or web pages or web page information. Preconfigured MMS section 530 may include text and/or graphics, and may be used for creating, or manufacturing, one or more advertisements. Such creation may include graphic design, and may be web and/or browser based. A target interface may be a portable, or mobile, device.

Response and request/reward section 540 may be used as a working activity region where selection may be correlated or rearranged, may be in accordance with a marketing or survey campaign or event, and such working activity may be by a user interface with an electronic media displaying display 500. Tools from tools section 520 may be selected to appear in response and request/reward section 540, and MMS messages may be selected from preconfigured MMS section 530, e.g., tools and/or MMS messages may be dragged and dropped into response and request/reward section 540. A tool that may be selected may also activate a flow in a composer utility, where such a flow may be relevant to a particular marketing campaign or event being designed or modified. A campaign may be executed in an order created by such a procedure. In some cases there may be more elements than may conveniently fit within response and request/reward section 540, and user-interface controls, e.g., scrolling, may be used to display additional elements and/or their temporal relationship to each other. Both activities related to sending messages and receiving messages or responses may be addressed in response and request/reward section 540. Response and request/reward section 540 may be further divided into response section 550 and request/reward section 560, or other sections as may be used to create and/or manage a marketing campaign or survey event. Response section 550 may be used for display and/or control of particular responses that may be expected from a consumer or survey respondent. Request/reward section 560 may be used for display and/or control of particular requests to be sent to a consumer, and may be used o initiate or continue a dialog, e.g., a marketing or survey dialog. Request/reward section 560 may be used display and/or control of particular rewards or incentives that may be sent to a consumer and may be in coincident to a response that may be received from a consumer.

Reference is now made to FIG. 5b, which is a block diagram of an embodiment of the invention. An interface may be an interface for a mobile dialog based system (MDBS) 570. A MDBS interface may be a web based interface and may have title 572. Display section 574 may provide an interface to a message composer and/or preconfigured MMS 530. Display section 500 may provide an interface to dialog flow designer and executor 576, or dialog composer interface. Display section 578 may provide an interface to database 110, which may be a behavioral database and/or another database. Display section 580 may provide an interface to a mobile gateway and/or MMP 100. Any interface may be used to create and/or edit corresponding subject matter.

A dialog processor, dialog generator and/or a dialog flow designer and executioner may be used to provide a designer of a campaign, or marketing campaign, an ability to form a full dialog flow. Such a flow may illustrate each element of a planned brand-consumer dialog, may simulate a compete flow and may provide a campaign manager with an ability to both fine-tune each element of a flow and simultaneously have a broad view, or big picture view, of a progress of a planned campaign. A short message service (SMS)/multimedia messaging service (MMS) composer may be designed to help a marketer build a commercial message by combining text and images in various ways. A dialog processor (DP) and/or a dialog flow designer and executioner may be built to manufacture a full two-way mobile dialog in a manner that may imitate a natural dialog between persons. Campaigns may be managed and/or controlled and/or monitored in a real-time system, and may reduce, for example a marketing lifecycle, and may enable live monitoring and/or near real time campaign amendments by a marketer.

A brand, a marketer, or an individual, may receive data and/or statistics, and/or monitor performance regarding a new or ongoing campaign via an interface, e.g., a dashboard. A unique login and/or password may be used to access a particular dashboard. Data may be presented that may describe a number of parameters, and may be used to determine success, performance and/or a progress of a campaign. Data may be available in real-time, or near real-time, and a campaign may be able to be evaluated dynamically. Such information may be used to steer and/or amend a campaign, and such amendments may be performed in near real-time. An illustrative example may be an offer of a discounted muffin may not be taken advantage of, and a brand may switch an offer to a discount for a doughnut. A campaign may be adjusted in near real-time, and during operation of a campaign. Near real-time campaign adjustments may be used to test campaigns, as such may be easy to implement via mobile device and/or SMS feedback. For example, a test campaign may be run in a specific geographical area, and may be extended to a wider area during a campaign.

A geographical area may be identified by exercising different unique “key words” that may correlate to a specific geographical area. A marketer, or individual, may simultaneously monitor performance of a campaign, that may be running, effectively in parallel, over a variety of geographical areas. Information may be sorted according to consumers' MSISDN and/or more specifically, a consumer's mobile area code. A good approximation may be provided of an actual geographical distribution versus a consumer's distribution. Near real-time campaign management and/or control may be realized. For example, multiple discount levels may be tested, to determine what may be best for a brand, such as determining a discount level of a product that may maximize store traffic, e.g., sales with a 5% discount versus sales with a 15% discount. A discount level may be an optimal discount level. Campaign efficiency may be optimized. A variety of information may be collected, e.g., date and time, including day and/or month or return data. For example, a coupon may be valid only during a specific time of day, and such time may be varied dynamically. Or, for example, a particular item may be offered for free in a given week, and another item may be offered for free in a subsequent week, and data, e.g., store traffic, may be collected and analyzed.

Coupons may be sent to segments by, for example regional segregators, e.g., a zip code. A segmentation may be, for example, no broader than a zip code. Feedback may be collected, and may be used in a fine resolution to define a “market of one.”

As a brand may become familiar with each of its engaged consumers, it may improve its digital marketing spending efficiency by omitting non-relevant message costs. Messages and marketing messages may be personalized according to a personal preference of each consumer, where such preferences may be learned through a dialog process. This may be referred to as methodologies and/or products.

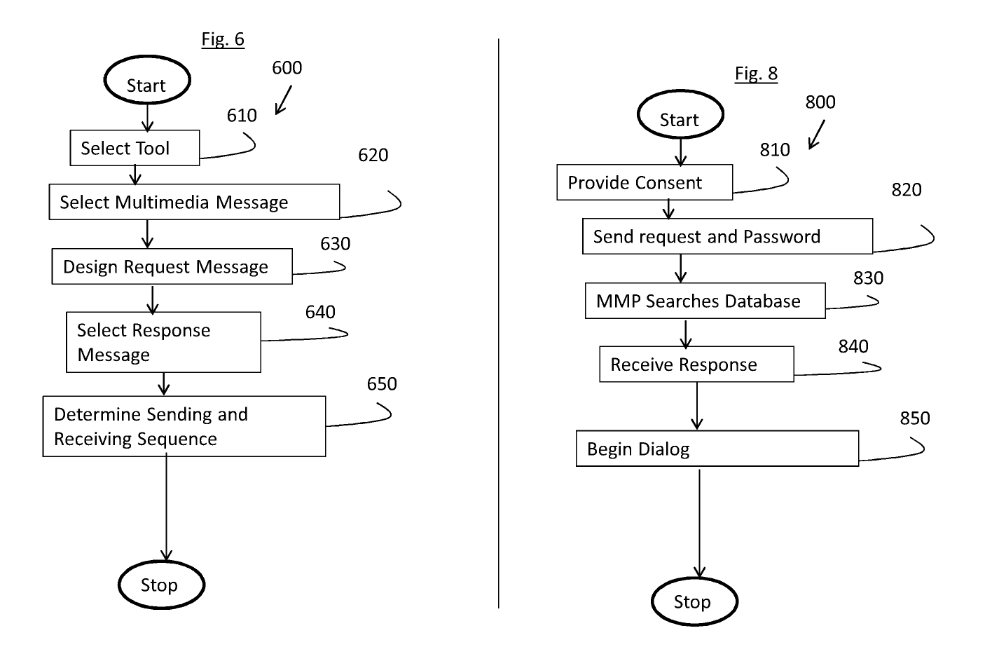

Reference is now made to FIG. 6, which is a flowchart illustrating operation of an exemplary method 600 for a marketing dialog configuration. A marketing dialog may be configured by using a user interface that may have display 500, and may be referred to as a Composer or a Campaign Composer. A composer may show a static display or may change display visualizations when certain elements, such as tools, multimedia messaging service (MMS) messages, etc. may be selected. A tool may be selected (operation 610) by referring to display of available tools 520 of display 500. A selection may be made by any means coincident with a user interface, for example a click selection or a drag and drop selection. A tool selected by a drag and drop may be dropped into a working area, such as response and request/reward area 540. A multimedia message may be selected (operation 620) by referring to display of available multimedia messages 530 of display 500. A multimedia message selected by a drag and drop may be dropped into a working area, such as response and request/reward area 540. Multimedia messages may be designed or may be selected from a preset or predetermined listing of available messages. A request message may be created, designed or modified (operation 630), by working with selected messages appearing in a response and request/reward area 540 of display 500. Request messages may be dragged and dropped, or otherwise selected, and arranged in request/reward section 560. Rewards and/or incentives may be selected and arranged similarly. Request and/or reward messages may be designed to be sent to mobile devices. Response messages may be selected, created, designed or modified (operation 640) and may be worked with or rearranged by reference to such messages appearing in response section 550 of display 500. Response messages may be designed to be sent from mobile devices, for example by limiting a response length, e.g., a three digit numerical sequence of “351”. A sequence of events may be determined, designed or modified (operation 650) by interfacing with a composer and display 500 through a user interface. An event sequence may be used to determine a dialog sequence for sending and receiving tools, multimedia messages, request messages and response messages, including surveys and survey responses. Event sequences may be used to instruct a mobile marketing platform to execute a marketing and/or survey campaign according to a designed sequence.

A DB may service groups, e.g., a mobile loyalty club or a mobile frequent engagers club, or the like. A consumer behavior DB may be continuously growing with use, and may enable a classification of consumers according to a criterion, for example a level of engagement, or loyalty, or other measure, e.g., frequency of engagement or quality of engagement or a combination of both. A consumer that may choose to continue a dialog with a specific brand may alter a classification within such a brand. Such a classification may relate to a level, e.g., a loyalty level or level of a consumer value ladder, or similar classification. For example, a consumer that may choose an increased amount of a dialog may be moved to a higher classification level. Higher classification levels may be associated with other elements, e.g., increased benefits, that may be granted to a consumer. A method may incorporate an identifier, e.g., a visual tag, that may include a designated color or wording identifier, e.g., a golden stripe or a word or phrase such as “Gold Member.” An identifier may be part of, within, or on a mobile message, and may indicate, in a clear way, either visual, textual or both, a status, e.g., seniority, level of a consumer, and may be displayed or communicated at each commercial engagement. Each such display may be associated or complimented with benefits, and such benefits may match a seniority level. A seniority level may be static or may change, where a change may be associated with a consumer moving up or down levels, e.g., up or down a value ladder.

A visual tag may have a plurality of purposes. It may provide an indication to a merchant of a seniority level, or loyalty level, of each consumer during a shopping process. It may also serve as an aide to a consumer to help appreciate a growing value of benefits that may be granted, and may be performed in a visual and an immediate manner. Such a manner may increase a sense of action and reward of a consumer, and may have an immediate impact and may increase a notion of dialog personalization, which may build loyalty. A visual tag may also help a brand to build a notion, e.g., a public notion, of groups of consumers, e.g., most valuable consumer groups, and may provoke a positive marketing influence, or buzz, that may be exhibited, or shown. For example, a first consumer and a second consumer may be associated with each other, as friends for example, and may shop together on occasion. A first consumer may be at a particular level, e.g., a gold member, and be furnished with more premium benefits that may match a corresponding seniority level, and a second consumer may be at a bronze level member, which may be a lower level, or tier. An emotional response may occur where a first consumer may “show off” a higher benefit level and premium status, and a second consumer may be encouraged, either directly or indirectly, to attempt to reach a corresponding premium level.

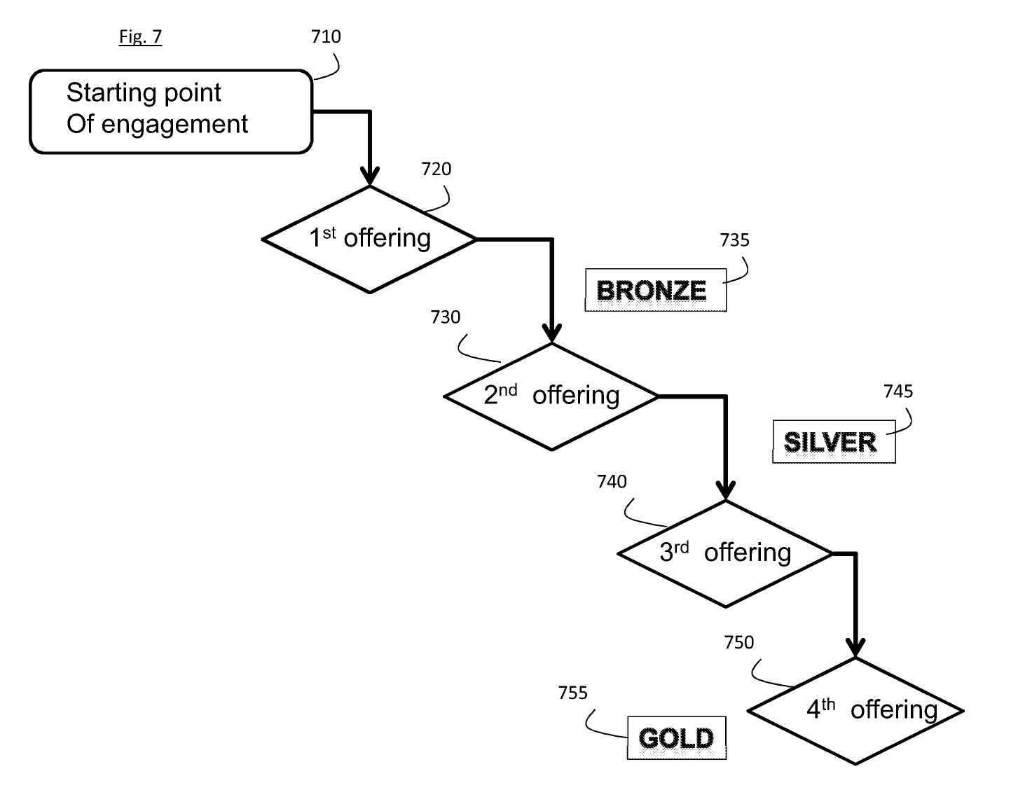

An exemplary flow of an engagement may be described by reference to FIG. 7. An engagement may be between a consumer and a brand and may begin 710 by a variety of methods, for example a display advertisement may be viewed by a consumer in or near a store. Such display may include instructions, for example, to send a text or SMS message to a particular number to receive a coupon, which may be a first offering 720. A store, or brand, may then capture a mobile phone number, e.g., the number of a mobile phone that was used to send an SMS, and this number may be stored as identifying information of a consumer by a mobile marketing platform, that may be locally or remotely located and physically or operably connected to a store. An offer, or coupon, may be redeemed by a consumer by bringing the mobile device into a store and presenting a display of a response message, or coupon, received on the mobile device at, for example, a point of sale. A redemption may be any form of display of a coupon, or other offer sent to a consumer, to a brand, store or point of sale, and such presentation may be by a mobile device. A redemption may be any provision of a benefit to a consumer in return for a consumer participating in a dialog. Redemptions may be used to, for example, increase traffic and/or a “foot print” in a store by offering incentives to consumers, and may or may not be tracked by individual coupon identifiers. Redemptions may be tracked by behavioral models, or circumstantially. An illustrative example of an embodiment may be a muffin coupon may be sent, and if a request for a second muffin coupon is received by an MMP, a system may conclude a first coupon was redeemed. A consumer may then enjoy a reward, e.g., a 5% discount off of a purchase or a free piece of cake, and a mobile marketing platform may record a redemption, transmission and/or engagement of a first offering incentive to an identified, e.g., by mobile number or mobile address, consumer. A second offer or incentive may be sent to a consumer 720 on a mobile device, e.g., a 10% discount. A mobile marketing platform may analyze a mobile number, and, recognizing a second offer is being sent, choose an improved offer and incrementally change, e.g., increase, a status of a consumer in a loyalty program, or similar incentive program. Along with a second offer, a visual display of a new loyalty program status 725 may be sent to a consumer's mobile device, e.g., a “Bronze” graphic where lettering may be displayed in a bronze color. A consumer may redeem a second offer in a similar manner as a first offer was redeemed, with a mobile device, and a mobile marketing platform may recognize a second redemption, transmission and/or engagement and send a third offering 730. Along with sending a third offering, a mobile marketing platform may analyze a second redemption associated with a particular mobile number, increase a consumer's status in a loyalty program and send a visual indication of such new status 735, e.g., a “Silver” graphic where lettering may be displayed in a silver color, once a next engagement may occur. A consumer may redeem a third offer in a similar manner as a first and second offer and a mobile marketing platform may recognize a second redemption and send a fourth offering 740, e.g., a 15% discount. Analysis as above may be performed, a consumer's loyalty status may be increased, and a mobile marketing platform may send a visual indication of such new status 745, e.g., a “Gold” graphic where lettering may be displayed in a gold color. In an embodiment, discounts or incentives may improve with increasing loyalty levels. Such increasing status indicators may help to increase good feeling of a consumer about a brand, and may also incentivize peers of a consumer to achieve similar loyalty status levels. A mobile marketing platform may send messages and/or responses and may increment loyalty levels of consumers according to instructions that may have been determined by a composer, user interface and display 500. A number of iterations or a number of loyalty levels may be in accordance with program rules, and may be any number of increments, levels or iterations. A consumer may also be decremented in a loyalty program according to certain events, e.g., inactivity for a predefined period of time.

A database, or a behavioral database, may also be a behavioral analytical database, or may be a behavioral database that may be acted upon in an analytical fashion. Such a database may record patterns that may be unique to a consumer, e.g., consumer behavior patterns, and such patterns may facilitate a dialog that may be long standing, voluntary, or both. A consumer may be furnished with and/or matched to a personal message that may be unique and/or personal, e.g., promotional or informational, and such matching may be operative to build trust and/or a loyalty between a consumer and a brand, that may be long-standing. A behavioral database may perform data mining of an individual consumer's behavior, and may do so in an elegant and/or voluntary manner. Data mining may be based on a preliminary cooperation and/or consent, or based on a voluntary mobile dialog method, e.g., an opt-in procedure. Data mining may be performed via a personal engagement with each consumer. Data may build up through a dialog that may be a non-intrusive and/or voluntary interaction, and may be designed to bring each consumer unique and/or valuable services. Data may be gathered through various engagements and may build up in a database, for example in a continuous process. Data may be analyzed, learned and/or utilized by a brand, and may be used to perfect future mobile campaigns. Brands may establish a close and personal dialog with related consumers, and may do so by a continuous learning process. Consumers may be provided with relevant and personalized consumer oriented marketing data that may facilitate innovative and/or improved mobile based customer experiences, and may build loyalty, revenue and/or profit. A consumer behavioral database may be leveraged to reach individuals, e.g., a “market of one,” via mobile devices.

A point of sale may have an ability to scan coupons from a mobile device, e.g., mobile phone, and may read a digital coupon, or similar item, from such mobile device. Identifying information may be recorded, and an MMP and/or a database may be able to detect a redemption and record such information accordingly. Such a scan with identifying information and recordation may be called a “closed loop” system.

In accordance with an embodiment of the invention, a method may operate in a system that may be referred to as “open loop.” A long standing dialog may provide a unique capability to draw certain conclusions about consumers and/or consumer behavior. Conclusions may be drawn with high certainty, and may closely approximate consumers and/or consumer behavior. For example, a consumer, that may choose to opt-in and/or may repeatedly continue an engagement, may most probably be receiving a benefit from a dialog process, e.g., messages received via a dialog may have been redeemed, enjoyed or otherwise utilized.

A behavioral database algorithm may contemplate both qualitative as well as quantitative behavioral patterns and/or parameters, and may be based on a process of upgrading and/or degrading a position in a loyalty ladder, and may be over a time period. For example, a consumer may be upgraded in a loyalty program, e.g., Mobile Frequent Engagers Club, among levels, e.g., bronze, silver, gold or platinum, on a quantitative basis. By illustrative example, a consumer may be elevated from a bronze level to a silver level by completing five database engagements, from a silver to a gold level by completing ten additional database engagements or from gold to platinum by completing twenty additional database engagements. A consumer may be upgraded in a Mobile Frequent Engagers Club between levels on a qualitative basis. For example, a consumer may be elevated from a bronze to a silver level after completing at least one survey, or customer satisfaction survey, from a silver to a gold level after aggregately purchasing greater than a predetermined value of goods or services. Any combination of qualitative and/or quantitative bases may be used to determine an upgrade, and/or a movement among various levels, of a consumer in a Mobile Frequent Engagers Club. For example, a consumer may be upgraded from a bronze level to a silver level after completing five database engagements, from a silver to a gold level after completing five additional database engagements and completing at least one consumer satisfaction survey, or from a gold to a platinum level after completing an additional fifteen database engagements and after purchasing goods or services valued of a predetermined value.

Reference is now made to FIG. 8, which is a flowchart illustrating operation of an exemplary method 800 for allowing a consumer to enable an anonymous disclosure of directed and/or relevant information, e.g., cross shopping, etc. An MMP may build a consumer behavioral database that may be unique to a brand, and several such databases may be created. A consumer may be provided an ability to inquire across and/or among such databases based on individual preferences and/or consumer behavioral preferences, and receive new offerings that may fit a profile of such a consumer. A process may be established to maintain anonymity of a consumer's identity, and keep a consumer in control of relevant information. A consumer may access an MMP system by, for example a web page, and create and/or access a login, for example a user ID and password. A login may include a mobile phone number, or other similar uniquely identifying information, a password, and/or other account information. Following a login, a consumer may provide consent 810 and accept terms of usage. A consumer may send to an MMP an inquiry of other brands and/or databases that may be relevant, based on behavioral information of such consumer, and such a request may be accompanied by a password 820. An MMP may search a database 830, and such a search may be based on a shopping and/or behavioral pattern of a consumer. A search 830 may be performed to find a new matching offer (e.g., cross access, cross shopping, collaborative filtering, etc.). A response that may be received 840 may provide, for example, a list of new offerings that a consumer may choose from, that may not have been previously presented to such consumer. New offerings may be generated by exercising an algorithm which may contemplate a previous activity that may be unique to a consumer and/or a consumer's personal preferences. A consumer may select from a presented list of offers, and may choose to begin a dialog 850 with one or more additional brands that may correspond to such offers presented.

An embodiment of the invention may enable consumers to proactively inquire upon a database and/or an MMP as to potentially available promotions and/or marketing events. Inquiries may be made upon a specific request of a consumer, and may be per one or more brand interests, per one or more product interests, per one or more geographical interests, or per other interests, and/or any combination. Each inquiry may maintain a maximum level of privacy for a consumer. A benefit may be that a brand may be able to reduce a marketing pressure, or push pressure, on consumers, and may alleviate a perception of intrusive spam from a brand. Another benefit may be multiple research efforts of brands may be reduced, and research efficiency may be increased. Consumers may be granted one or more opportunities to voluntarily and/or relevantly inquire about a variety of products and/or services, and may be in accordance with a consumer's unique interest, at a consumer's convenience and/or during a consumer's free time. A consumer may be prevented from being pushed to disclose accurate or identifying location information, either involuntarily or voluntarily, e.g., on a social network site such as Facebook or Twitter, and specificity of a disclosure may be controlled by a consumer. Involuntary disclosure may be by tracking from location based service (LBS) technologies and/or methods, e.g., network-based techniques, handset-based technology, global positioning system (GPS) technology, etc. By way of illustrative example, a consumer may inquire by utilizing a text message combination, in accordance to a wish and/or need, by providing multiple brand combinations. A combination may be Target plus Dona Karen, may be Target plus Dona Karen plus suites, may be Target plus Dona Karen plus New York City, may be Macy's perfume, may be Macy's perfume plus San Francisco, may be Stop & Shop plus sodas, may be C&D plus house detergents, or may be C&D plus toothpaste plus Philadelphia. A specific promotion that may be requested by a consumer may not be available at a time of a request, and other similar and/or relevant product and/or service offerings may be available in a system database. An inquiring consumer may be asked whether a corresponding, or matching, offer may be made. A consumer may accept a matching offer by providing approval to receive such offer, and such offer may be sent to a consumer via a mobile device. A consumer may enjoy a benefit and/or a power of a specific local shopping experience without being tracked involuntarily (e.g., through various network based techniques, handset-based technology, and/or global positioning system (GPS) technology) and/or forced to publicly disclose the consumer's specific location, (e.g. on any social networking website such as Facebook and/or Twitter, or any other information exchange device, that may be available via electronic network).

A consumer may be invited to add a favorite brand, or a short code corresponding to a brand, to a consumer's database record, or address book, and may encourage such consumer to engage with such brands at a convenience of a consumer. Such a choice may be enabled in an easy and/or relevant way.

An example of an embodiment that may illustrate a dialog that may occur at a department store location may be as follows. A more exact need of a consumer may be better found by using a dialog, e.g., a multi-optional answers dialog. A consumer may send a message, e.g., “Tell me (brand),” where (brand) may be a name of a specific brand. A brand may respond with a response message, e.g., “For Women please reply 1; for Men 2.” Upon subsequent engagements by such a consumer, and by being identified by a same identifier, e.g., a mobile phone number, an MMP and/or database may provide a response that may be based on previous preferences, and may include a matching offer. Suggestions to receive additional and/or alternative offers may be included in responses. For example, a response may be, “25% off Men's suits, for more promos; reply with ‘more’”: Responses may be focused on relevancy to a consumer, and may be based on an existing relationship. Relevancy may be to a number of factors, such as a location, or inquiry location, and/or specific needs, desires, and/or behavioral patterns.

In an embodiment of the invention, a consumer may send an inquiry to a system, e.g., an MMP and database, and may tell a system which brands a consumer may have a previous, or preexisting, relationship with. Such a request may be sent with a password, and/or key, and a password and/or a key may be a one-time use variety. A key may include a time stamp identifier, a phone number, or other unique and/or identifying information and/or any combination, etc. If a combination of one or more requested items may be available, for example in a database, a system may respond with one or more offers, and such offers may be specific to a consumer. If items may not be available, a system may send related offers, or ask a consumer if related offers may be sent. Inquiries made by a consumer regarding other brands may be considered cross shopping and/or collaborative filtering.

In an embodiment of the invention, coupons may be bundled for a specific presentation to a consumer, and a presentation may be made via a mobile device. Bundling may be complimentary or non-complementary. Bundling may be a combination of two or more coupons, and may be designed for presentation on a mobile device. Coupons and/or bundled coupons may be available via a mobile device, and may be a mobile coupon. Mobile coupons and/or bundled mobile coupons may be dynamically created to target an individual. Bundling may be based on certain parameters, for example geographically based bundling. Bundling may be performed in real-time, or near real-time, by a marketer of a brand changing a bundling and providing such new bundling to consumers via mobile devices. A marketer of a brand may be an individual and/or an individual that may be associated with a brand. Multiple offers or offer combinations may be available at an onset of a dialog. A consumer may choose a combination of offers that may be accepted. By selecting offers based on a consumer preference, bundling may be unique to a consumer or consumer preferences.

Complementary bundling may be a group of two or more offers selected by a marketer of a brand to be presented to a consumer, where there may be a relationship between the offers or coupons, and such relationship may be a direct relationship, e.g., an offer for a shirt and an offer for a tie. A consumer may select such a bundling, or may request an alternate bundling. Non-complementary bundling may be a group of two or more offers selected by a marketer of a brand to be presented to a consumer, where there may not be a direct relationship between the offers or coupons, e.g., an offer for a pair of shoes and an offer for a muffin. In both such cases a dialog may not assume or anticipate a response of a consumer. Rather, a consumer is provided with a choice, and a consumer may reply by making a choice, e.g., selecting offer bundling 1 or offer bundling 2. A mobile marketing platform (MMP) may adapt by offering different offer bundles to consumers based on selections of consumers.

An embodiment of the invention may present certain advantages. Mobile marketing and advertising may be closely related to online or Internet advertising, however, mobile means may have a greater reach, or market penetration or potential. Mobile advertising may be targeted toward mobile phones, and global estimates of available phones, including advanced mobile phones/computing platforms, e.g., iPhones, may be approximately 4.6 billion, or greater. Computers, including desktop computers and laptop computers, may be estimated to have numbers of approximately 1.1 billion units globally. Advertisers and/or media industries may increase applications directed toward a mobile market, as mobile media may be rapidly evolving, where mobile phones, or mobile devices with telephony capability, may remain a mainstay unit. Mobile phones may outnumber devices, e.g., television sets, by noticeable ratios, e.g., 3 to 1, and may outnumber personal computer-based Internet users by other ratios, e.g., 4 to 1. Certain countries may allow mobile advertising to be distributed to mobile devices, e.g., approximately 75% of mobile users in Spain, 62% of mobile users in France and 54% of mobile users in Japan may receive advertisements on mobile devices. Mobile marketing may be a growing market, may provide good prospects for innovation, and mobile advertising may be growing, e.g., by 85%, during relatively static economic conditions. Large numbers, e.g., greater than 50%, of consumers have utilized mobile phones for in-store holiday shopping activities. Many retailers, e.g., 75%, may have plans for engaging consumers in a mobile space.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method for managing a mobile based dialog, comprising:
receiving a first response to a dialog request;
storing said first response;
analyzing said first response; and
sending a second response based on said analysis, wherein said second response includes one or more of an inquiry to continue said dialog or a redeemable reward.

2. The method of claim 1, wherein said receiving further comprises receiving said first response from a mobile device.

3. The method of claim 2, wherein said mobile device is one device selected from the set of a mobile telephone, a cellular telephone, a smartphone, an Internet-connected wireless phone or a handheld computing device.

4. The method of claim 1, wherein said sending further comprises sending said second response to a mobile device.

5. The method of claim 4, wherein said mobile device is one device selected from the set of a mobile telephone, a cellular telephone, a smartphone, an Internet-connected wireless phone or a handheld computing device.

6. The method of claim 1, wherein said first response is stored in a database.

7. The method of claim 6, wherein said database is a behavioral database.

8. The method of claim 7, wherein said behavioral database further comprises a database that records individual behavior patterns of consumers.

9. The method of claim 8, wherein said behavioral database collects information using a mobile device based dialog, where said dialog is between a consumer and a brand, and is managed by a mobile marketing platform.

10. The method of claim 9, wherein said behavioral database is operably connected to one or more additional databases containing any type of information, and information is shared among all said databases.

11. The method of claim 1, wherein said first response further comprises identifying information.

12. The method of claim 11, wherein said analysis further comprises determining a loyalty level.

13. The method of claim 12, wherein said second response further comprises notice of said loyalty level.

14. The method of claim 13, wherein said notice further comprises a visual display of said loyalty level.

15. The method of claim 1, wherein said inquiry further comprises a request to continue a dialog.

16. The method of claim 1, wherein said redeemable reward further comprises a request to continue a dialog.

17. The method of claim 1, wherein said dialog is part of a marketing campaign.

18. The method of claim 17, wherein said analysis is based at least on a strategy element of said marketing campaign.

19. The method of claim 1, wherein said dialog request is made by a static display.

20. The method of claim 19, wherein said static display is located near a point of sale.

21. The method of claim 1 wherein said dialog request is made via a web page.

22. The method of claim 1, wherein said first response and said second response each further comprise a bundling of two or more offers.

23. The method of claim 22, wherein said bundling is complementary.

24. The method of claim 22, wherein said bundling is non-complementary.

25. The method of claim 24, wherein said bundling is an alternative combination.

26. The method of claim 1, wherein said dialog is longstanding.

27. The method of claim 1, wherein said redeemable reward comprises a coupon.

28. The method of claim 1, wherein said redeemable reward comprises a QR code, the QR code including data selected from the data group consisting: shop ID, campaign ID, coupon serial number, engaged customer ID and customer's mobile phone number.

29. A method for participating in a marketing data dialog, comprising:
sending a first message according to a notice;
receiving a response to said message, wherein said response includes an offer; and
sending a second message, wherein said second message includes an indicator of acceptance of said offer.

30. The method of claim 29, wherein said notice is a static display.

31. The method of claim 30, wherein said static display is located near a point of sale of the entity displaying said notice.

32. The method of claim 29, wherein said notice is received by a mobile device.

33. The method of claim 29, wherein said sending and said receiving is performed using a mobile device.

34. The method of claim 29, wherein said first message includes a confirmation of opting into said dialog.

35. The method of claim 29, wherein said offer is at least one of a redeemable incentive or a survey.

36. The method of claim 29, wherein said second message includes an indicator of agreement to participate in said dialog.

37. The method of claim 29, wherein said acceptance of said offer includes an increment of a level in a loyalty program.

38. The method of claim 37, wherein said increment is an increase of one or more steps.

39. The method of claim 29, wherein said acceptance of said offer includes an indicator to receive a notice.

40. The method of claim 39, wherein said indicator comprises a consent to continue said dialog.

41. The method of claim 29, wherein said offer comprises a coupon.

42. The method of claim 1, wherein said offer comprises a QR code, the QR code including data selected from the data group consisting: shop ID, campaign ID, coupon serial number, engaged customer ID and customer's mobile phone number.
